(19) United States
(12) Patent Application Publication
(10) Pub. No.: US 2026/0300208 A1
(43) Pub. Date: Oct. 1, 2026

(54) FLEXIBLE CHIPLET ARCHITECTURE WITH BANDWIDTH AGGREGATION

(71) Applicant: QUALCOMM Incorporated, San Diego, CA (US)

(72) Inventors: Sang TRAN, Encinitas, CA (US); Rongtian ZHANG, San Diego, CA (US)

(21) Appl. No.: 19/090,053

(22) Filed: Mar. 25, 2025

(51) Int. Cl. G06F 13/42

(52) U.S. Cl. CPC G06F 13/4221; G06F 2213/0026

(57) ABSTRACT

A flexible chiplet-based system is provided in which each chiplet in an array of chiplets includes a plurality of UCIe modules. Depending upon the bandwidth mode of aggregation and the dimensionality of the array, a source chiplet in the chiplet-based system may aggregate a bandwidth for the UCIe modules in a data transmission from the source chiplet to a destination chiplet.

### TECHNICAL FIELD

The present application relates generally to chiplets, and more particularly to a chiplet-based system with bandwidth aggregation.

### BACKGROUND

Portable computing devices (“PCDs”) are becoming necessities for people on personal and professional levels. These devices may include cellular telephones, portable digital assistants (“PDAs”), portable game consoles, palmtop computers, and other portable electronic devices. PCDs typically have complex and compact electronic packaging that is generally made of multiple processing units that include central processing units, digital signal processors, and the like. Much of this hardware may be part of a system on a chip (“SOC”) design as understood by one of ordinary skill in the art.

An individual element in an SOC may be better suited for a particular semiconductor processing node as compared to the remaining elements. Integrating all the elements into a single integrated circuit thus involves a compromise with respect to its process node. The heterogenous integration of individual chiplets in a chiplet-based system as an alternative to an SOC allows the process node and materials for each chiplet to be individually optimized for improved performance and cost. In addition, an individual chiplet in the system may be redesigned without requiring redesign of the remaining chiplets. The use of chiplets also avoids the SOC need for a relatively large die size that may result in lower yields.

### SUMMARY

In accordance with an aspect of the disclosure, a chiplet-based system is provided that includes: a first chiplet including a first data interface and including a second data interface; a second chiplet including a third data interface and including a fourth data interface; and at least one additional chiplet, wherein the chiplet-based system is configurable into a first mode of operation in which the first chiplet is configured to transmit a first data transmission having a first bandwidth through the first data interface to the third data interface, and wherein the chiplet-based system is configurable into a second mode of operation in which the first chiplet is configured to transmit the first data transmission of the first mode of operation and is configured to transmit a second data transmission having a second bandwidth from the second data interface through the at least one additional chiplet to the fourth data interface.

In accordance with another aspect of the disclosure, a method for a chiplet-based system is provided that includes: transmitting a first data transmission having a first bandwidth from a first data interface in a first chiplet through a first plurality of interconnects to a second data interface in a second chiplet during a first mode of operation for the chiplet-based system; and transmitting the first data transmission of the first mode of operation while transmitting a second data transmission having the first bandwidth from a third data interface in the first chiplet through at least one additional chiplet to a fourth data interface in the second chiplet during a second mode of operation for the chiplet-based system.

Finally, in accordance with yet another aspect of the disclosure, a source chiplet for a chiplet-based system is provided that includes: a first UCIe module configured to transmit and receive a first bandwidth of data; a second UCIe module configured to transmit and receive the first bandwidth of data; and an at least one processor configured in a first bandwidth aggregation mode of operation to control the first UCIe module to transmit a first data transmission to a destination chiplet in the chiplet-based system and configured in a second bandwidth aggregation mode of operation to control the first UCIe module to transmit the first data transmission to the destination chiplet and the second UCIe module to transmit a second data transmission to the destination chiplet.

These and other advantageous features may be better appreciated through the following detailed description.

### BRIEF DESCRIPTION OF THE DRAWINGS

FIG. 1 illustrates a UCIe module for a chiplet-based system as disclosed herein.

FIG. 2 illustrates a chiplet-based system having bandwidth aggregation in accordance with an aspect of the disclosure.

FIG. 3 is a diagram of a chiplet for a chiplet-based system having bandwidth aggregation in accordance with an aspect of the disclosure.

FIG. 4 illustrates an intra-chiplet routing circuit for a chiplet-based system having bandwidth aggregation in accordance with an aspect of the disclosure.

FIG. 5 is a flowchart for a method of aggregating bandwidth in a chiplet-based system in accordance with an aspect of the disclosure.

Implementations of the present disclosure and their advantages are best understood by referring to the detailed description that follows. It should be appreciated that like reference numerals are used to identify like elements illustrated in one or more of the figures.

### DETAILED DESCRIPTION

A chiplet is an integrated circuit that contains a well-defined subset of functionality for a chiplet-based system. Once a chiplet is designed, it may be advantageously included in diverse chiplet-based systems such as through a mix-and-match assembly on an interposer. Each chiplet in a chiplet-based system may be fabricated with different semiconductor processes, materials, and nodes such that each chiplet may be optimized for its particular subset of functionality. Since chiplets may be manufactured by different companies, various die-to-die interconnect communication protocols have been developed for chiplet-based systems so that interoperability may be assured despite their differing manufactures.

One protocol that has become a de facto chiplet communication protocol is known as Universal Chiplet Interconnect express (UCIe) due to its high-bandwidth, low latency, power efficiency, and advantages. Depending upon the implementation such as the dimensionality of the chiplet array, a chiplet may include a plurality of data interfaces. In a planar chiplet array (two-dimensional array), a chiplet may include up to four data interfaces for communicating with other chiplets in a UCIe-compliant chiplet-based system. In a three-dimensional array, a chiplet may include up to six data interfaces. Each data interface may also be denoted as a UCIe module with a chiplet having up to four modules in a planar implementation. As will be discussed further herein, each module includes a mainband data interface for general data communication and a corresponding sideband interface for management and control signals with respect to the mainband data interface, clocking and synchronization, and security and authentication. Through a mainband interface (and its corresponding sideband interface), a chiplet may have a point-to-point connection with another chiplet (or with a device external to the chiplet-based system). But the resulting point-to-point connection is neither flexible nor scalable.

A chiplet-based system is disclosed in which the bandwidth from one die-to-die data interface may be aggregated with one or more additional die-to-die data interfaces. The resulting chiplet-based system may thus be deemed to have a flexible chiplet architecture due to this ability to aggregate the bandwidths from various die-to-die interfaces. The following discussion will assume that the die-to-die interfaces are UCIe interfaces, but it will be appreciated that the bandwidth aggregation disclosed herein is applicable to other data interface protocols.

With regard to the bandwidth aggregation in a planar chiplet-based system, each chiplet die will typically have a rectangular perimeter. The four resulting sides of the perimeter of the die include an upper side of the perimeter (which may also be denoted as a north side), a right side of the perimeter (which may also be denoted as an east side), a left side of the perimeter (which may also be denoted as a west side), and a bottom side of the perimeter (which may also be denoted as a south side). Note that the use of cardinal designations for the perimeter sides is arbitrary and does not imply any given orientation with the true cardinal directions. Given these designations, each chiplet in some planar array implementations may have one or more UCIe modules for each side of the perimeter that is dedicated to the data communication between the chiplet and another chiplet. In a three-dimensional array, each chiplet may include one or more UCIe modules for the four perimeter sides and also for its upper and lower die surfaces. In the planar chiplet-based systems disclosed herein, the chiplets may be deemed to be arranged into an array such that an internal chiplet to the array may have another chiplet facing each side of the internal chiplet's rectangular perimeter. In alternative implementations, the chiplets in the array may also be stacked such that there are three dimensions to the array. Thus, although the following discussion will be directed to two-dimensional chiplet arrays, it will be appreciated that the bandwidth aggregation disclosed herein is also applicable to three-dimensional (or higher) arrays.

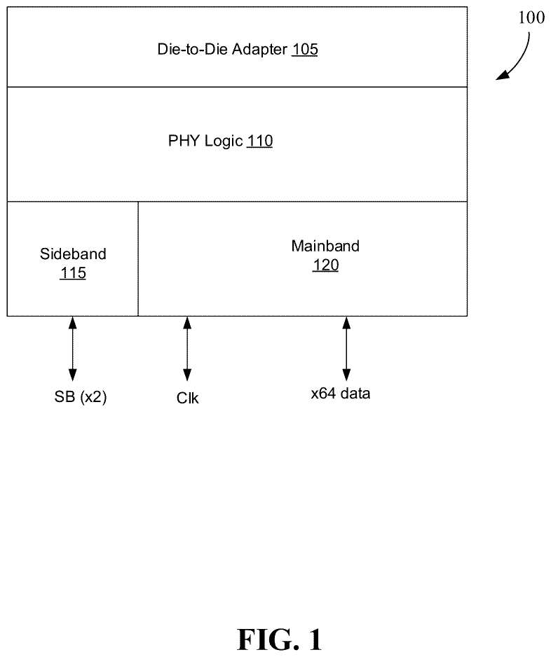

An example UCIe module 100 for a chiplet-based system as disclosed herein is shown in more detail in FIG. 1. Module 100 includes multiple layers of hardware and software modules, including a die-to-die adaption layer 105 that may be configured to manage inter-die communication, a physical layer (PHY) logic 110 that controls and manages the electrical characteristics of analog front-end circuits, and the configuration of logic circuits used to transmit or receive over a mainband interface 120 and/or a sideband interface 115. The mainband interface 120 provides up to a nominal 64-bit mainband data path in both transmit and receive directions that are synchronized according to a clock signal (CLK). The sideband interface 115 provides a nominal 2-bit control and management signal path in both the transmit and receive directions as well. Within a corresponding chiplet, each UCIe module such as the UCIEe module 100 may be initialized and trained independently.

Depending upon the implementation, the UCIe module 100 may be bound with an additional UCIe module to form a UCIe data interface. Such a UCIe data interface would then support up to 128-bit mainband data path. Alternatively, the UCIe module 100 may be bound with three additional UCIe modules to form a UCIe data interface. The UCIe modules in the chiplet-based systems disclosed herein may thus comprise one of, two of, four of, or a combination thereof of the UCIe module 100.

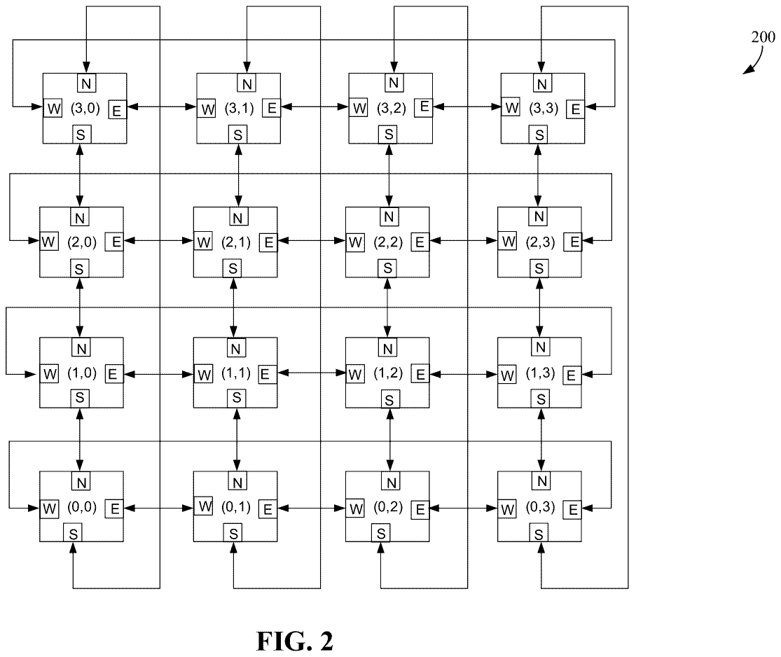

An example chiplet-based system having an array 200 of chiplets is shown in FIG. 2. Array 200 includes sixteen chiplets, but it will be appreciated that fewer or greater number of chiplets may be included in alternative implementations. In general, an array of chiplets for the chiplet-based systems disclosed herein is arranged into rows and columns of chiplets. In array 200, there are four rows ranging from a zeroth row to a third row and four columns ranging from a zeroth column to a third column. It will be appreciated, however, that the array size with respect to the number of rows and columns may be smaller or larger than four in alternative implementations.

Within the array 200, each chiplet may be identified by a (row, column) index. The zeroth row thus spans from a chiplet (0,0) to a chiplet(0,3). The chiplet (0,0) is positioned at an intersection of the zeroth row and the zeroth column. Similarly, the (0,3) chiplet (0,3) is positioned at an intersection of the zeroth row and the third column. A first row of chiplets is analogous and thus includes a chiplet (1,0), a chiplet (1,1), a chiplet (1,2), and a chiplet (1,3). Similarly, a second row of chiplets includes a chiplet (2,0), a chiplet (2,1), a chiplet (2,2), and a chiplet (2,3). Finally, a third row of chiplets includes a chiplet (3,0), a chiplet (3,1), a chiplet (3,2), and a chiplet (3,3).

Each module has a certain amount of bandwidth that depends upon its implementation. Under the UCIe protocol, a module may transmit at least a sixteen-bit data word but depending upon the implementation the word size may be increased by sixteen-bit increments to up to 64 bits. The bandwidth (or equivalently, the bits per second) that a module may transmit or receive is thus dependent on the word size and the word transmission rate. But the resulting bandwidth for a module is fixed once a designer implements a given word size and transmission rate. There is thus a bandwidth limit on the data transmission from one chiplet to another should the data transmission from a chiplet be restricted to a single module. This bandwidth limitation may not be satisfactory for high-bandwidth applications. To accommodate an advantageously greater bandwidth, the chiplets in the array 200 are configurable to route data from more than one module in one chiplet to corresponding modules in another chiplet. The following discussion will address the data transmission from a source chiplet to a destination chiplet, but it will be appreciated that the bandwidth aggregation disclosed herein is applicable to broadcast or multicast transmissions from a source chiplet.

In a default mode, the bandwidth for a data transmission from a source chiplet to a destination chiplet is limited to a one-module bandwidth through a direct connection from one chiplet's module to another chiplet's module. With regard to this direct connection, the four chiplets (2,1), (2,2), (1,1), and (1,2) may be deemed as internal chiplets to the array in that each of their four sides of their dies' rectangular perimeters faces a side of a neighboring chiplet. For example, consider the north, south, east, and west sides of the chiplet (2,1). As will be explained further herein, terminals (not shown in FIG. 2) from a north-side module (N) of the chiplet (2,1) connect to terminals of a south-side module (S) of the chiplet (3,1). Similarly, terminals from a south-side module of the chiplet (2,1) connect to corresponding terminals of a north-side module of the chiplet (1,1). In addition, terminals from an east-side module (E) connect to corresponding terminals of a west-side module (W) of the chiplet (2,2). Finally, terminals of a west-side module of the chiplet (2,1) connect to corresponding terminals of an east-side module of the chiplet (2,0). Each of the remaining internal chiplets (2,2), (1,1), and (1,2) may also have four modules that analogously couple to the neighboring chiplet's modules.

The remaining chiplets in the array have at least one side along a perimeter of the array 200 such that the one side does not face any other modules. Should such a side of a die perimeter face either the east or west side of the array perimeter, terminals from the corresponding east-side or west-side module couple across the array to a west-side or east-side module in the same row but on the other side of the array's perimeter. For example, terminals from a west-side module in the chiplet (2,0) couple to terminals of an east-side module in the chiplet (2,3). In the same fashion, should the terminals from a module face either the north end or the south end of a column in the array 200, the terminals may be coupled across the array to corresponding terminals of a module at an opposing end of the column. For example, the north-side module of the chiplet (3,0) is coupled to a south-side module of the chiplet (0,0).

Given these direct module-to-module connections, each chiplet can communicate over a one-module bandwidth to a directly-connected module. But one chiplet may need to communicate with a chiplet with which it does not have a direct connection. For example, suppose the chiplet (3,0) needs to communicate with the chiplet (3,2). As will be explained further herein, each chiplet may be configured for an intra-chiplet routing from one of its module to another. For example, a chiplet's east-side module may transmit signals routed intra-chiplet from the chiplet's west-side, north-side, or east-side modules. To accommodate this routing from a source chiplet to a destination chiplet, an assigned chiplet (e.g., one of the internal chiplets (2,1), (2,2), (1,1), or (1,2) may broadcast architecture parameters (for example, the word size) and setup routing parameters for the chiplet-to-chiplet routing. The source chiplet may negotiate its data transmission routing following a predetermined routing rule. In one example implementation, the routing from a chiplet's east-side or west-side module to another chiplet in the same row of the array may be deemed to be an X-direction routing. Conversely, the routing from a chiplet's north-side or south-side module to another chiplet in the same column of the array may be deemed to be a Y-direction routing. Given these directions, an example predetermined routing rule may be routing first in the X-direction for data transmission from either an east-side or west-side module followed by a Y-direction routing. For example, suppose that the source chiplet is the chiplet (2,1) and the destination chiplet is the chiplet (3,2). Should a single module bandwidth be sufficient, the resulting routing according to the X-first rule would be from the east-side module of the chiplet (2,1) to the west-side module of the chiplet (2,2). After an intra-chiplet routing from the west-side module to the north-side module of the chiplet (2,2), the routing would be from the north-side module of the chiplet (2,2) to the south-side module of the destination chiplet (3,2). Data transmission from a source chiplet to a destination chiplet using a one-module bandwidth occurs during what may also be denoted herein as a first mode of operation or as a first bandwidth aggregation mode of operation for a chiplet-based system.

But such a one-module transmission bandwidth may be insufficient for a desired communication mode. The routing is thus configurable such that a two-module bandwidth, a three-module bandwidth, or even a four-module bandwidth may be implemented from a source chiplet to a destination chiplet. For example, suppose that a two-module bandwidth is desired for communication between two chiplets in the same row such as between the chiplet (2,1) and chiplet (2,2). In addition to the direct connection between the east-side module of the chiplet (2,1) and the west-side module of the chiplet (2,2), data transmitted from the west-side module of the chiplet (2,1) may be received by the east-side module of the chiplet (2,0) and intra-chiplet routed to be transmitted from the west-side module of the chiplet (2,0) to the east-side module of the chiplet (2,3). After being intra-chiplet routed in the chiplet (2,3), the data may be transmitted from the west-side module of the chiplet (2,3) to be received by the east-side module of the chiplet (2,2). Data transmitted from the chiplet (2,2) to the chiplet (2,1) may similarly be routed in the reverse order as just described for the data flow from the chiplet (2,1) to the chiplet (2,2).

The doubling of the bandwidth between any two chiplets in the remaining rows is analogous. With regard to this doubling, the west-side module of a chiplet at the west end of a row of chiplets may be interconnected with the east-side module at the east end of the row. For example, chiplets in the zeroth column have terminals to their west-side modules that may be interconnected with corresponding terminals of the east-side module for the same-row chiplet in the third column. Similarly, the terminals for a west-side module of the chiplet (3,0) thus network with the corresponding terminals for an east-side module of the chiplet (3,3). In the same fashion, the terminals for a west-side module of the chiplet (1,0) are networked with the corresponding terminals for an east-side module of the chiplet (1,3). Finally, the terminals for a west-side module of the chiplet (0,0) are networked with the corresponding terminals for an east-side module of the chiplet (0,3).

A similar two-module bandwidth may be used for the communication between two chiplets in a column of the array such as between the chiplet (3,1) and the chiplet (1,1). In particular, the chiplet (3,1) may transmit a first data transmission having a one-module bandwidth from its south-side module to the north-side module of the chiplet (2,1). After an intra-chiplet routing, the chiplet (2,1) transmits the first data transmission from its south-side module to the north-side module of the chiplet (1,1). The chiplet (3,1) may transmit a second data transmission having the one-module bandwidth from its north-side module to the south-side module of the (0,1) chiplet. After being intra-chiplet routed in the chiplet (0,1), the data may be transmitted from the north-side module of the chiplet (0,1) to the south-side module of the chiplet (1,1). Data transmission from chiplet (1,1) to the chiplet (3,1) would be analogous but in the reverse order.

The north side of the chiplets in the third row are also on the external perimeter of the array and thus do not face another chiplet. The terminals for a north-side module in each third row chiplet may thus be interconnected with the corresponding terminals for a zeroth-row chiplet's south-side module in the same column. The terminals for a north-side module of the chiplet (3,0) thus network with the corresponding terminals for a south-side module of the chiplet (0,0). Similarly, the terminals for a north-side module of the chiplet (3,1) are networked with the corresponding terminals for a south-side module of the chiplet (0,1). In the same fashion, the terminals for a north-side module of the chiplet (3,2) are networked with the terminals for a south-side module of the chiplet (0,2). Finally, the terminals for a north-side module of the chiplet (3,3) are networked with the terminals for a south-side module of the chiplet (0,3).

A two-module bandwidth data routing may also occur from a chiplet in one row and column to a chiplet in another row and another column. For example, suppose that chiplet (2,1) must send to the chiplet (3,2) data that can only be accommodated through two modules. To do so, the chiplet (2,1) may transmit a first data transmission having a one-module bandwidth from its east-side module to the west-side module of the chiplet (2,2). From the north-side module of the chiplet (2,2), the data continues to the south-side module of the chiplet (3,2). To transmit a second data transmission having a one-module bandwidth to chiplet (3,2), the chiplet (2,1) transmits the second data transmission out of its north-side module to the south-side module of the chiplet (3,1). After an intra-chiplet routing, the data is then transmitted from the east-side module of the chiplet (3,1) to the west-side module of the chiplet (3,2). The resulting data transmission from a source chiplet to a destination chiplet using a two-module bandwidth occurs during what may also be denoted herein as a second mode of operation or as a second bandwidth aggregation mode of operation for a chiplet-based system.

The aggregation of three one-module bandwidths is analogous. For example, suppose that the chiplet (2,1) is the source chiplet and the chiplet (2,2) is the destination chiplet. Two bandwidths of this three-bandwidth aggregation between these two chiplets has already been described. To accommodate the third bandwidth, the chiplet (2,1) may transmit from its north-side module to the south-side module of the chiplet (3,1). After an intra-chiplet routing, the chiplet (3,1) may then transmit the data from its east-side module to the west-side module of the chiplet (3,2) whereupon after another intra-chiplet routing the chiplet (3,2) may transmit the data from its south-side module to the north-side module of the chiplet (2,2). The resulting data transmission from a source chiplet to a destination chiplet using a three-module bandwidth occurs during what may also be denoted herein as a third mode of operation or as a third bandwidth aggregation mode of operation for a chiplet-based system.

The aggregation of four bands is also analogous. For example, suppose again that the chiplet (2,1) is the source chiplet and the chiplet (2,2) is the destination chiplet. Three bandwidths of this four-bandwidth aggregation between these two chiplets has already been described. To accommodate the fourth bandwidth, the chiplet (2,1) may transmit from its south-side module to the north-side module of the chiplet (1,1). After an intra-chiplet routing, the chiplet (1,1) may then transmit the data from its east-side module to the west-side module of the chiplet (1,2) whereupon after another intra-chiplet routing the chiplet (1,2) may transmit the data from its north-side module to the south-side module of the chiplet (2,2). The resulting data transmission from a source chiplet to a destination chiplet using a four-module bandwidth occurs during what may also be denoted herein as a fourth mode of operation or as a fourth bandwidth aggregation mode of operation for a chiplet-based system.

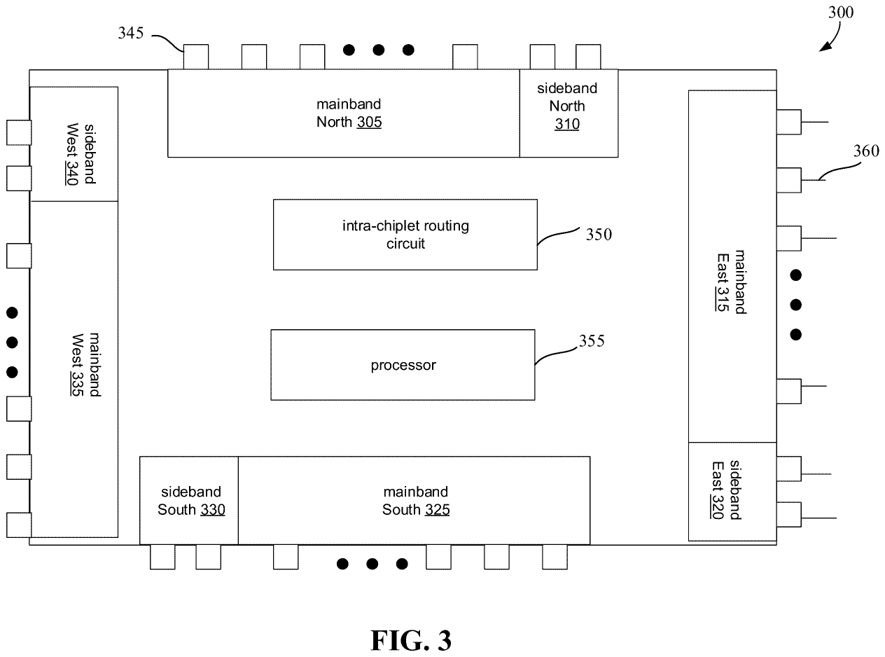

An example chiplet 300 is shown in more detail in FIG. 3. A north-side module includes a mainband data interface 305 and a sideband interface 310. Similarly, an east-side module includes a mainband data interface 315 and a sideband interface 320. In the same fashion, a south-side module includes a mainband data interface 325 and a sideband interface 330. Finally, a west-side module includes a mainband data interface 335 and a sideband interface 340. Each mainband data interface may support up to sixty-four input and output data signals (sixteen input and output data signals being the standard package under the UCIe protocol) with each input and output data signal be transmitted or received over a corresponding terminal 345. Alternatively, it can include 4 UCIe modules for each side, or any combination thereof. Each standard package implementation of a UCEe module has a mainband 16-bit or an 8-bit data interface whereas each advanced package implementation of a UCIe module has a 64-bit or a 32-bit data interface. Each side (East, West, South, and North) of a chiplet perimeter may be associated with than one multi-module standard package and/or multi-module advanced package. Each sideband interface enables link training, low-speed data communication, and parameter exchange as transmitted or received over corresponding terminals 345.

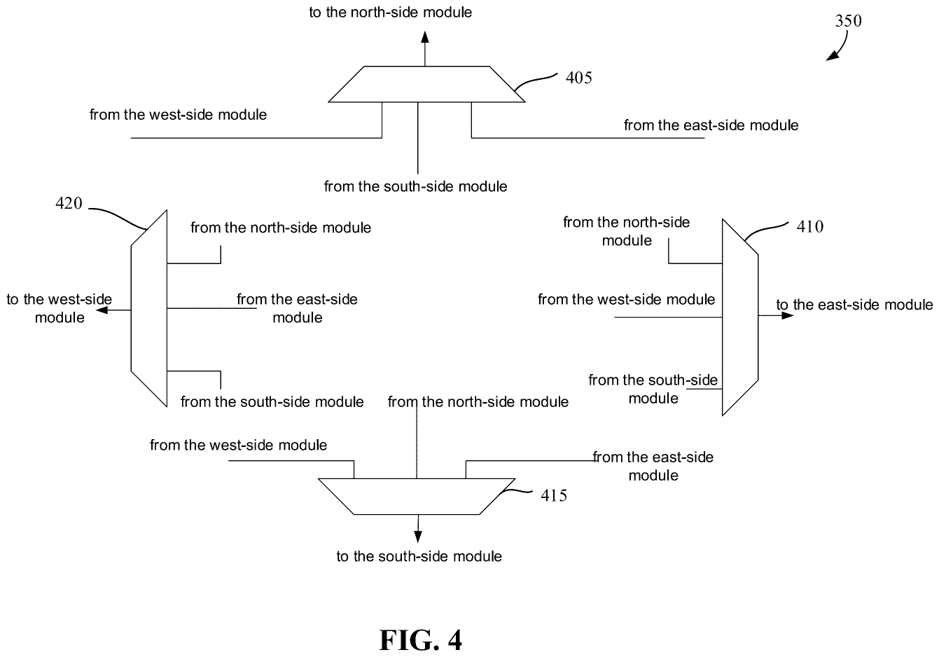

The bandwidth aggregation modes of operation for the UCIe modules and the routing by an intra-chiplet routing circuit 350 are controlled by a suitable controller such as one or more processors 355. The intra-chiplet routing circuit 350 is shown in more detail in FIG. 4. Should data be intra-chiplet routed to the chiplet's north-side module, a north-side multiplexer 405 selects from data routed from the chiplet's east-side module, south-side module, and west-side module. An example of such a routing would be included within the four-bandwidth aggregation discussed earlier with respect to the chiplet (1,2) performing an intra-chiplet routing from its west-side module to its north-side module. In that case, the north-side multiplexer 405 would be controlled to select for the data input from the west-side module.

Similarly, should data be intra-chiplet routed to a chiplet's east-side module, an east-side multiplexer 410 selects from data routed from the chiplet's west-side, north-side, and south-side modules. An example of such an intra-chiplet routing would be included within the two-bandwidth aggregation discussed earlier with respect to the chiplet (3,1) performing an intra-chiplet routing from its south-side module to its east-side module. In such a routing, the east-side multiplexer 410 would be controlled to select for the data input from the south-side module.

In addition, should data be intra-chiplet routed to a chiplet's south-side module, a south-side multiplexer 415 selects from data routed from the chiplet's west-side, north-side, and east-side modules. An example of such an intra-chiplet routing would be included within the three-bandwidth aggregation discussed earlier with respect to the chiplet (3,2) performing an intra-chiplet routing from its west-side module to its south-side module. In such a routing, the south-side multiplexer 415 would be controlled to select for the data input from the west-side module.

Finally, should data be intra-chiplet routed to a chiplet's west-side module, a west-side multiplexer 420 selects from data routed from the chiplet's north-side, east-side, and south-side modules. An example of such an intra-chiplet routing would be included within the two-bandwidth aggregation discussed earlier with respect to the chiplet (2,0) performing an intra-chiplet routing from its east-side module to its west-side module. In such a routing, the west-side multiplexer 420 would be controlled to select for the data input from the east-side module.

With respect to the intra-chiplet routing, a data transmission may include a source address field and include a destination address field. The source address may be represented by a variable X and the destination address may be represented by variable Y such the source and destination address may be represented by a combination variable (X,Y). In addition, a data transmission may include a bandwidth aggregation field to identify whether the transmission is one-band, two-band, three-band, or four-band. Another field may be used to identify the routing rule. Should the chiplet 300 be the source chiplet of a data communication, the processor 355 may be configured to negotiate the routing for the data communication following the predetermined routing rule. In one example of such a rule, should either an east-side or west-side module be transmitting data from a chiplet, the subsequent routing through the chiplet array continues in the X direction first before any subsequent Y-directed routing. Similarly, should either a north-side or south-side module be transmitting data from a chiplet, the subsequent routing through the chiplet array continues in the Y direction before any X-directed routing. When a destination chiplet receives the data, it may transmit an acknowledgement back to the source chiplet following the same routing rules. Should a destination chiplet be unreachable because all the available bands are being used, the source chiplet may wait for a pre-determined time and try again. Alternatively, a different routing may be attempted. A data transmission may also include a field for a priority scheme such as a quality of service (QoS), the X,Y distance for the routing, and the data transfer size. These various fields may be transmitted by a mainband data interface or by a sideband interface.

Referring again to the chiplet array 200 of FIG. 2, it may be seen that row and column arrangement determines the coupling between the UCIe modules. Within a row of the chiplet array, the east-side module of a chiplet connects to the west-side module of a neighboring chiplet in the row (assuming that the row continues to the east of chiplet having the east-side module). For example, the east-side module of the chiplet (3,2) is connected through corresponding interconnections to the west-side module of the chiplet (3,3). Should a chiplet be the east-most chiplet within a row, then its east-side module interconnects with the west-side module of the west-most chiplet in the row. For example, since the chiplet (3,3) is the east-most chiplet and the chiplet (3,0) is the west-most chiplet in the third row of the array, the east-side module of the chiplet (3,3) is coupled through interconnections such as conductive leads in an interposer on which the chiplet array is mounted to the west-side module of the chiplet (3,0). Portions of some example interconnections 360 are shown in FIG. 3 for the east-side module of the chiplet 300.

The column interconnection is analogous in that the south-side module of a chiplet in a column connects to the north-side module of a neighboring chiplet in the column (assuming that the column continues to the south of the chiplet having the south-side module). For example, the south-side module of the chiplet (3,0) is connected to the north-side module of the chiplet (2,0). But if a chiplet is the south-most chiplet in a column, then its south-side module coupled to the north-side module of the north-most chiplet in the column. For example, the south-side module of the chiplet (0,0) couples to the north-side module of the chiplet (3,0).

Referring again to FIG. 2, the maximum routing delay occurs from one corner of the array to the opposing corner. To provide a better appreciation of this maximum routing delay, suppose that the chiplet (0,0) is the source chiplet and the that the chiplet (3,3) is the destination chiplet. The routing delay will be the same regardless of whether the data transmission is one-band, two-band, three-band, or four-band. For example, one band transmission may occur from the west-side module of the chiplet (0,0) through the chiplets (0,1) and (0.2) to the west-side module of the chiplet (0,3), which results in a three-chiplet routing delay. After an intra-chiplet routing, the chiplet (0,3) may transmit the data from its south-side module to the north-side module of the chiplet (3,3) such that the maximum routing delay is a four-chiplet routing delay. A similar four-chiplet routing delay occurs for each of the the additional three bands that may be routed from the chiplet (0,0) to the chiplet (3,3).

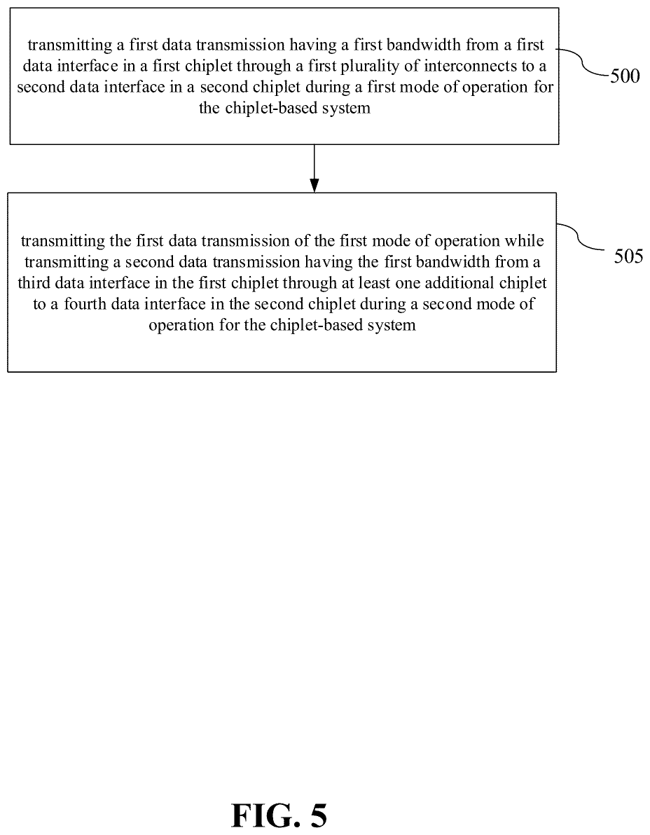

A method of bandwidth aggregation for a chiplet-based system will now be discussed as illustrated in the flowchart of FIG. 5. The method includes an act 500 of transmitting a first data transmission having a first bandwidth from a first data interface in a first chiplet through a first plurality of interconnects to a second data interface in a second chiplet during a first mode of operation for the chiplet-based system. A data transmission from the east-side module of the chiplet (2,2) to the west-side module of the chiplet (2,3) in the array 200 of FIG. 2 is an example of act 500. The method also includes an act 505 of transmitting the first data transmission of the first mode of operation while transmitting a second data transmission having the first bandwidth from a third data interface in the first chiplet through at least one additional chiplet to a fourth data interface in the second chiplet during a second mode of operation for the chiplet-based system. The data transmission from the east-side module of the chiplet (2,2) in conjunction with a data transmission from the west-side module of the chiplet (2,2) that is then routed through the chiplets (2,0) and the chiplet (2,3) to the east-side module of the chiplet (2,2) is an example of act 505.

Some example implementations will now be summarized through the following numbered clauses:
Clause 1. A chiplet-based system comprising:
   a first chiplet including a first data interface and including a second data interface;
   a second chiplet including a third data interface and including a fourth data interface; and
   at least one additional chiplet, wherein the chiplet-based system is configurable into a first mode of operation in which the first chiplet is configured to transmit a first data transmission having a first bandwidth through the first data interface to the third data interface, and wherein the chiplet-based system is configurable into a second mode of operation in which the first chiplet is configured to transmit the first data transmission of the first mode of operation and is configured to transmit a second data transmission having a second bandwidth from the second data interface through the at least one additional chiplet to the fourth data interface.
Clause 2. The chiplet-based system of clause 1, wherein the first data interface, the second data interface, the third data interface, and the fourth data interface each comprises a mainband data interface of a corresponding universal chiplet interconnect express (UCIe) module, and wherein the first bandwidth is equal to the second bandwidth.
Clause 3. The chiplet-based system of any of clauses 1-2, wherein the first chiplet, the second chiplet, and the at least one additional chiplet are arranged in a first row of an array of chiplets in the chiplet-based system.
Clause 4. The chiplet-based system of clause 3, wherein the at least one additional chiplet comprises a third chiplet including a fifth data interface coupled to the second data interface and comprises a fourth chiplet including a sixth data interface coupled to the fourth data interface, and wherein the first row begins with the first chiplet and ends with the third chiplet, the second chiplet is adjacent the first chiplet, and the fourth chiplet is positioned between the second chiplet and the third chiplet.
Clause 5. The chiplet-based system of clause 4, wherein the first chiplet is included within a first die having a first rectangular perimeter and the second chiplet is included within a second die having a second rectangular perimeter, wherein a first side of the first rectangular perimeter is positioned to face a second side of the second rectangular perimeter, the chiplet-based system further comprising:
   a first plurality of interconnects extending from the first side to the second side to connect the first data interface to the third data interface.
Clause 6. The chiplet-based system of clause 5, wherein the first rectangular perimeter includes a third side at a first end of the first row, and wherein the third chiplet is included within a third die having a third rectangular perimeter having a fourth side at a second end of the row, the chiplet-based system further comprising:
   a second plurality of interconnects extending from the third side to the fourth side to connect the second data interface to the fifth data interface.
Clause 7. The chiplet-based system of clause 1, wherein the first chiplet, the second chiplet, and the at least one additional chiplet are arranged in a column of an array of chiplets in the chiplet-based system.
Clause 8. The chiplet-based system of clause 3, wherein the first chiplet further includes a fifth data interface and the second chiplet further includes a sixth data interface, the chiplet-based system further comprising:
   a second row of chiplets in the array, wherein the chiplet-based system is configurable into a third mode of operation in which the first chiplet is configured to transmit the first data transmission and the second data transmission of the second mode of operation and is configured to transmit a third data transmission having the first bandwidth from the fifth data interface through at least two chiplets in the second row to the sixth data interface.
Clause 9. The chiplet-based system of clause 8, wherein the first chiplet further includes a seventh data interface and the second chiplet further includes an eighth data interface, the chiplet-based system further comprising:
   a third row of chiplets in the array, wherein the chiplet-based system is configurable into a fourth mode of operation in which the first chiplet is configured to transmit the first data transmission, the second data transmission, and the third data transmission of the third mode and is configured to transmit a fourth data transmission having the first bandwidth from the fifth data interface through at least two chiplets in the third row to the sixth data interface.
Clause 10. A method for a chiplet-based system, comprising:
   transmitting a first data transmission having a first bandwidth from a first data interface in a first chiplet through a first plurality of interconnects to a second data interface in a second chiplet during a first mode of operation for the chiplet-based system; and
   transmitting the first data transmission of the first mode of operation while transmitting a second data transmission having the first bandwidth from a third data interface in the first chiplet through at least one additional chiplet to a fourth data interface in the second chiplet during a second mode of operation for the chiplet-based system.
Clause 11. The method of clause 10, wherein transmitting the first data transmission comprises transmitting the first data transmission from a first UCIe module in the first chiplet through the first plurality of interconnects to a second UCIe module in the second chiplet.
Clause 12. The method of clause 11, wherein transmitting the second data transmission comprises transmitting the second data transmission from a second UCIe module in the first chiplet through at least two additional UCIe modules in the at least one additional chiplet to a fourth UCIe module in the second chiplet.
Clause 13. The method of any of clauses 10-12, wherein the first chiplet, the second chiplet, and the at least one additional chiplet are arranged into a first row of an array of chiplets in the chiplet-based system, the method further comprising:
   transmitting the first data transmission and the second data transmission of the second mode of operation while transmitting a third data transmission having the first bandwidth from a fifth data interface in the first chiplet through at least two chiplets in a second row of the array to a sixth data interface in the second chiplet during a third mode of operation for the chiplet-based system.
Clause 14. The method of any of clauses 10-13, further comprising:
   negotiating a configuration for the first data transmission and for the second data transmission responsive to a predetermined routing rule.
Clause 15. The method of any of clauses 10-14, further comprising:
   transmitting an acknowledgement from the second chiplet to the first chiplet of a receipt of the first data transmission and the second data transmission at the second chiplet.
Clause 16. A source chiplet for a chiplet-based system, comprising:
   a first UCIe module configured to transmit and receive a first bandwidth of data;
   a second UCIe module configured to transmit and receive the first bandwidth of data; and
   at least one processor configured in a first bandwidth aggregation mode of operation to control the first UCIe module to transmit a first data transmission to a destination chiplet in the chiplet-based system and configured in a second bandwidth aggregation mode of operation to control the first UCIe module to transmit the first data transmission to the destination chiplet and the second UCIe module to transmit a second data transmission to the destination chiplet.
Clause 17. The source chiplet of clause 16, wherein a combined bandwidth of the first data transmission and the second data transmission is twice as large as the first bandwidth.
Clause 18. The source chiplet of any of clauses 16-17, further comprising:
   a third UCIe module configured to transmit and receive the first bandwidth of data, wherein the at least one processor is configured in a third bandwidth aggregation mode to control the first UCIe module to transmit the first data transmission to the destination chiplet, the second UCIe module to transmit a second data transmission to the destination chiplet, and the third UCIe module to transmit a third data transmission to the destination chiplet.
Clause 19. The source chiplet of clause 18, wherein a combined bandwidth of the first data transmission, the second data transmission, and the third data transmission is three times as large as the first bandwidth.
Clause 20. The source chiplet of clause 18, further comprising:
   a fourth UCIe module configured to transmit and receive the first bandwidth of data, wherein the at least one processor is configured in a fourth bandwidth aggregation mode to control the first UCIe module to transmit the first data transmission to the destination chiplet, the second UCIe module to transmit a second data transmission to the destination chiplet, the third UCIe module to transmit a third data transmission to the destination chiplet, and the fourth UCIe module to transmit a fourth data transmission to the destination chiplet, and wherein a combined bandwidth of the first data transmission, the second data transmission, the third data transmission and the fourth data transmission is four times as large as the first bandwidth.

As those of some skill in this art will by now appreciate and depending on the particular application at hand, many modifications, substitutions and variations can be made in and to the materials, apparatus, configurations and methods of use of the devices of the present disclosure without departing from the scope thereof as defined by the appended claims. In light of this, the scope of the present disclosure should not be limited to that of the particular implementations illustrated and described herein, as they are merely by way of some examples thereof, but rather, should be fully commensurate with that of the claims appended hereafter and their functional equivalents.

What is claimed is:

1. A chiplet-based system comprising:
a first chiplet including a first data interface and including a second data interface;
a second chiplet including a third data interface and including a fourth data interface; and
at least one additional chiplet, wherein the chiplet-based system is configurable into a first mode of operation in which the first chiplet is configured to transmit a first data transmission having a first bandwidth through the first data interface to the third data interface, and wherein the chiplet-based system is configurable into a second mode of operation in which the first chiplet is configured to transmit the first data transmission of the first mode of operation and is configured to transmit a second data transmission having a second bandwidth from the second data interface through the at least one additional chiplet to the fourth data interface.

2. The chiplet-based system of claim 1, wherein the first data interface, the second data interface, the third data interface, and the fourth data interface each comprises a mainband data interface of a corresponding universal chiplet interconnect express (UCIe) module, and wherein the first bandwidth is equal to the second bandwidth.

3. The chiplet-based system of claim 1, wherein the first chiplet, the second chiplet, and the at least one additional chiplet are arranged in a first row of an array of chiplets in the chiplet-based system.

4. The chiplet-based system of claim 3, wherein the at least one additional chiplet comprises a third chiplet including a fifth data interface coupled to the second data interface and comprises a fourth chiplet including a sixth data interface coupled to the fourth data interface, and wherein the first row begins with the first chiplet and ends with the third chiplet, the second chiplet is adjacent the first chiplet, and the fourth chiplet is positioned between the second chiplet and the third chiplet.

5. The chiplet-based system of claim 4, wherein the first chiplet is included within a first die having a first rectangular perimeter and the second chiplet is included within a second die having a second rectangular perimeter, wherein a first side of the first rectangular perimeter is positioned to face a second side of the second rectangular perimeter, the chiplet-based system further comprising:
a first plurality of interconnects extending from the first side to the second side to connect the first data interface to the third data interface.

6. The chiplet-based system of claim 5, wherein the first rectangular perimeter includes a third side at a first end of the first row, and wherein the third chiplet is included within a third die having a third rectangular perimeter having a fourth side at a second end of the row, the chiplet-based system further comprising:
a second plurality of interconnects extending from the third side to the fourth side to connect the second data interface to the fifth data interface.

7. The chiplet-based system of claim 1, wherein the first chiplet, the second chiplet, and the at least one additional chiplet are arranged in a column of an array of chiplets in the chiplet-based system.

8. The chiplet-based system of claim 3, wherein the first chiplet further includes a fifth data interface and the second chiplet further includes a sixth data interface, the chiplet-based system further comprising:
a second row of chiplets in the array, wherein the chiplet-based system is configurable into a third mode of operation in which the first chiplet is configured to transmit the first data transmission and the second data transmission of the second mode of operation and is configured to transmit a third data transmission having the first bandwidth from the fifth data interface through at least two chiplets in the second row to the sixth data interface.

9. The chiplet-based system of claim 8, wherein the first chiplet further includes a seventh data interface and the second chiplet further includes an eighth data interface, the chiplet-based system further comprising:
a third row of chiplets in the array, wherein the chiplet-based system is configurable into a fourth mode of operation in which the first chiplet is configured to transmit the first data transmission, the second data transmission, and the third data transmission of the third mode and is configured to transmit a fourth data transmission having the first bandwidth from the fifth data interface through at least two chiplets in the third row to the sixth data interface.

10. A method for a chiplet-based system, comprising:
transmitting a first data transmission having a first bandwidth from a first data interface in a first chiplet through a first plurality of interconnects to a second data interface in a second chiplet during a first mode of operation for the chiplet-based system; and
transmitting the first data transmission of the first mode of operation while transmitting a second data transmission having the first bandwidth from a third data interface in the first chiplet through at least one additional chiplet to a fourth data interface in the second chiplet during a second mode of operation for the chiplet-based system.

11. The method of claim 10, wherein transmitting the first data transmission comprises transmitting the first data transmission from a first UCIe module in the first chiplet through the first plurality of interconnects to a second UCIe module in the second chiplet.

12. The method of claim 11, wherein transmitting the second data transmission comprises transmitting the second data transmission from a second UCIe module in the first chiplet through at least two additional UCIe modules in the at least one additional chiplet to a fourth UCIe module in the second chiplet.

13. The method of claim 10, wherein the first chiplet, the second chiplet, and the at least one additional chiplet are arranged into a first row of an array of chiplets in the chiplet-based system, the method further comprising:
transmitting the first data transmission and the second data transmission of the second mode of operation while transmitting a third data transmission having the first bandwidth from a fifth data interface in the first chiplet through at least two chiplets in a second row of the array to a sixth data interface in the second chiplet during a third mode of operation for the chiplet-based system.

14. The method of claim 10, further comprising:
negotiating a configuration for the first data transmission and for the second data transmission responsive to a predetermined routing rule.

15. The method of claim 10, further comprising:
transmitting an acknowledgement from the second chiplet to the first chiplet of a receipt of the first data transmission and the second data transmission at the second chiplet.

16. A source chiplet for a chiplet-based system, comprising:
a first UCIe module configured to transmit and receive a first bandwidth of data;
a second UCIe module configured to transmit and receive the first bandwidth of data; and
at least one processor configured in a first bandwidth aggregation mode of operation to control the first UCIe module to transmit a first data transmission to a destination chiplet in the chiplet-based system and configured in a second bandwidth aggregation mode of operation to control the first UCIe module to transmit the first data transmission to the destination chiplet and the second UCIe module to transmit a second data transmission to the destination chiplet.

17. The source chiplet of claim 16, wherein a combined bandwidth of the first data transmission and the second data transmission is twice as large as the first bandwidth.

18. The source chiplet of claim 16, further comprising:
a third UCIe module configured to transmit and receive the first bandwidth of data, wherein the at least one processor is configured in a third bandwidth aggregation mode to control the first UCIe module to transmit the first data transmission to the destination chiplet, the second UCIe module to transmit a second data transmission to the destination chiplet, and the third UCIe module to transmit a third data transmission to the destination chiplet.

19. The source chiplet of claim 18, wherein a combined bandwidth of the first data transmission, the second data transmission, and the third data transmission is three times as large as the first bandwidth.

20. The source chiplet of claim 18, further comprising:
a fourth UCIe module configured to transmit and receive the first bandwidth of data, wherein the at least one processor is configured in a fourth bandwidth aggregation mode to control the first UCIe module to transmit the first data transmission to the destination chiplet, the second UCIe module to transmit a second data transmission to the destination chiplet, the third UCIe module to transmit a third data transmission to the destination chiplet, and the fourth UCIe module to transmit a fourth data transmission to the destination chiplet, and wherein a combined bandwidth of the first data transmission, the second data transmission, the third data transmission and the fourth data transmission is four times as large as the first bandwidth.
